(19) United States
(12) Patent Application Publication
(10) Pub. No.: US 2018/0236931 A1
(43) Pub. Date: Aug. 23, 2018

(54) Bicycle Signaling System

(71) Applicant: Alim Abdullah, Tacoma, WA (US)

(72) Inventor: Alim Abdullah, Tacoma, WA (US)

(21) Appl. No.: 15/437,306

(22) Filed: Feb. 20, 2017

(51) Int. Cl. B60Q 1/26; F21L 4/02; F21V 33/00; F21V 23/04; F21V 23/06; A41D 1/00; A41D 3/00; A42B 3/04; B62K 23/06; B62J 6/00; B62J 6/16

(52) U.S. Cl. CPC B60Q 1/2673; F21Y 2115/10; F21V 33/0008; F21V 23/0442; F21V 23/06; A41D 1/002; A41D 3/00; A42B 3/0453; A42B 3/044; B60Q 1/2696; B62K 23/06; B62J 6/005; B62J 6/003; B62J 6/16; F21L 4/02

(57) ABSTRACT

A bicycle signaling system includes a bicycle that may be ridden. The bicycle a pair of brake handles and each of the brake handles is selectively manipulated to stop the bicycle. A jacket is provided and the jacket may be worn while riding the bicycle. A helmet is provided and the helmet may be worn while riding the bicycle. A signaling unit is provided and the signaling unit is coupled to the bicycle. The signaling unit is in communication with each of the brake handles such that the signaling unit is turned on when the brake handles are manipulated. A lighting unit is coupled to the jacket to selectively emit light thereby facilitating the lighting unit to communicate a stop signal, a right turn signal and a left turn signal. The lighting unit is in electrical communication with the signaling unit.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIE THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

### (2) Description of Related Art Including Information Disclosed Under 37 CFR 1.97 and 1.98

The disclosure and prior art relates to signaling devices and more particularly pertains to a new signaling device for signaling when a bicycle is stopping, making a right hand turn and making a left hand turn.

### BRIEF SUMMARY OF THE INVENTION

An embodiment of the disclosure meets the needs presented above by generally comprising a bicycle that may be ridden. The bicycle a pair of brake handles and each of the brake handles is selectively manipulated to stop the bicycle. A jacket is provided and the jacket may be worn while riding the bicycle. A helmet is provided and the helmet may be worn while riding the bicycle. A signaling unit is provided and the signaling unit is coupled to the bicycle. The signaling unit is in communication with each of the brake handles such that the signaling unit is turned on when the brake handles are manipulated. A lighting unit is coupled to the jacket to selectively emit light thereby facilitating the lighting unit to communicate a stop signal, a right turn signal and a left turn signal. The lighting unit is in electrical communication with the signaling unit.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a front view of a jacket of a bicycle signaling system according to an embodiment of the disclosure.

FIG. 2 is a back view of jacket of an embodiment of the disclosure.

FIG. 3 is a perspective view of a helmet of an embodiment of the disclosure.

FIG. 4 is a perspective view right shoulder of a jacket of an embodiment of the disclosure.

FIG. 5 is a perspective view of an embodiment of the disclosure.

FIG. 6 is a perspective in-use view of an embodiment of the disclosure.

### DETAILED DESCRIPTION OF THE INVENTION

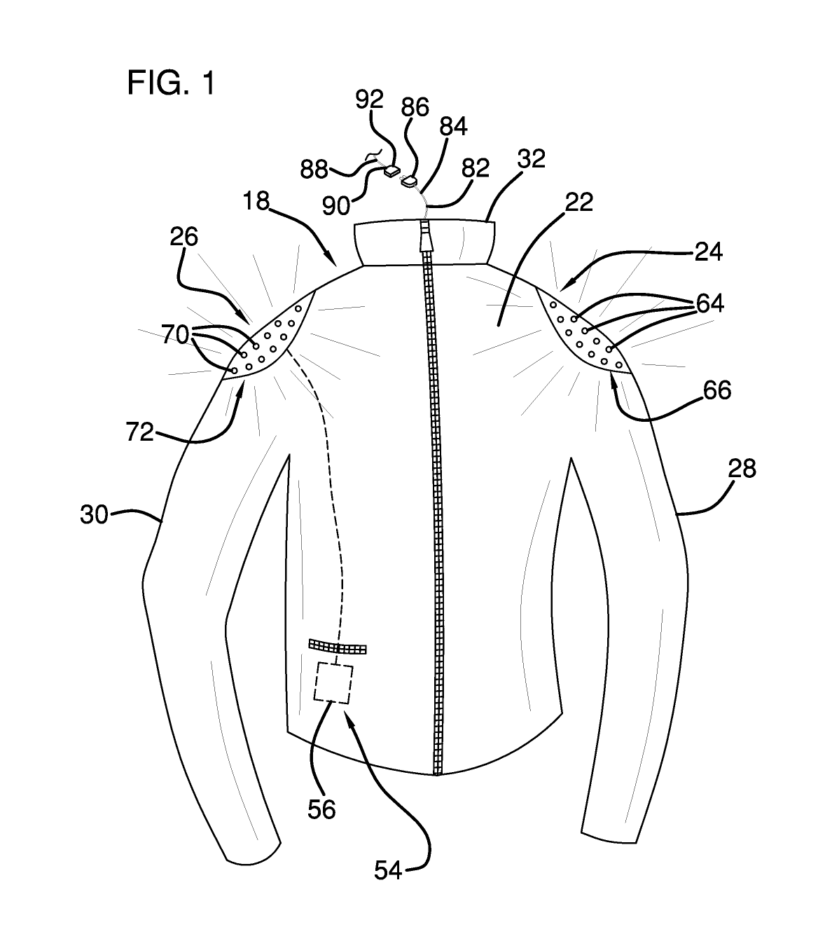

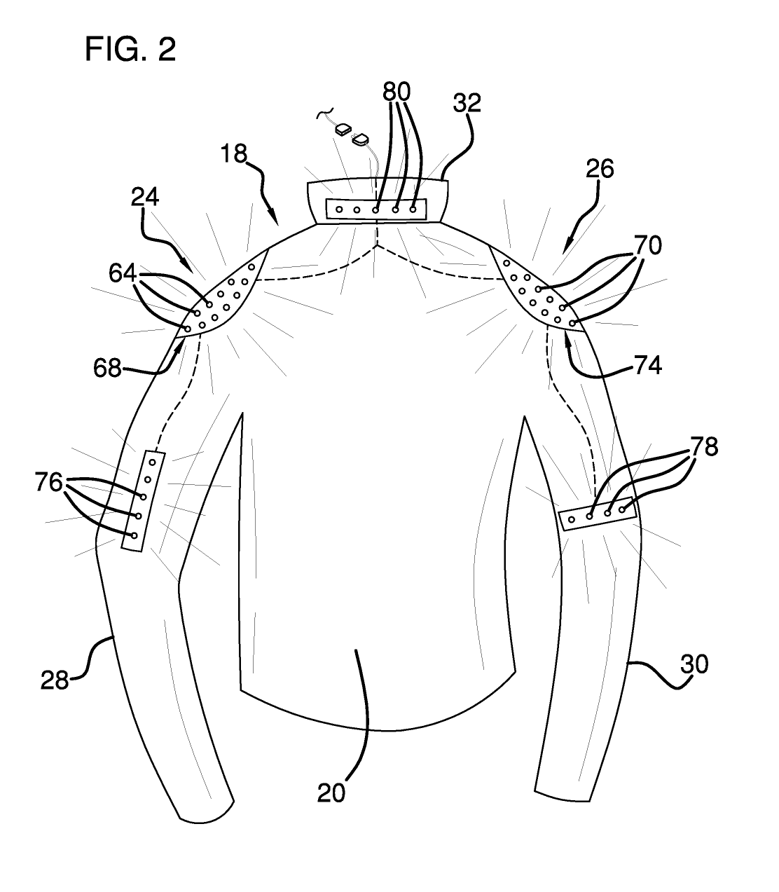

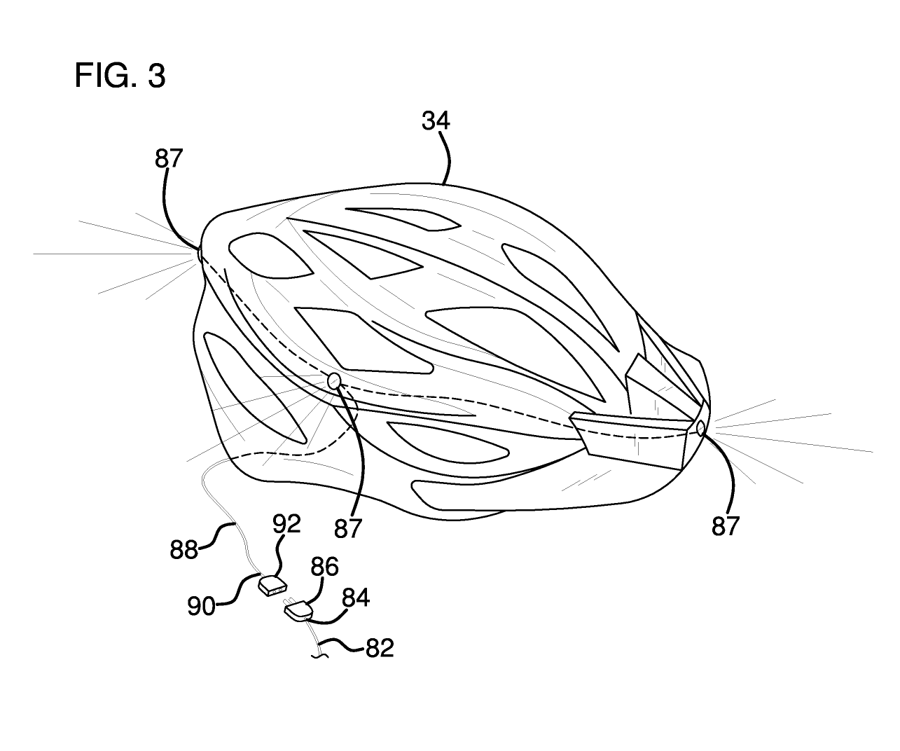

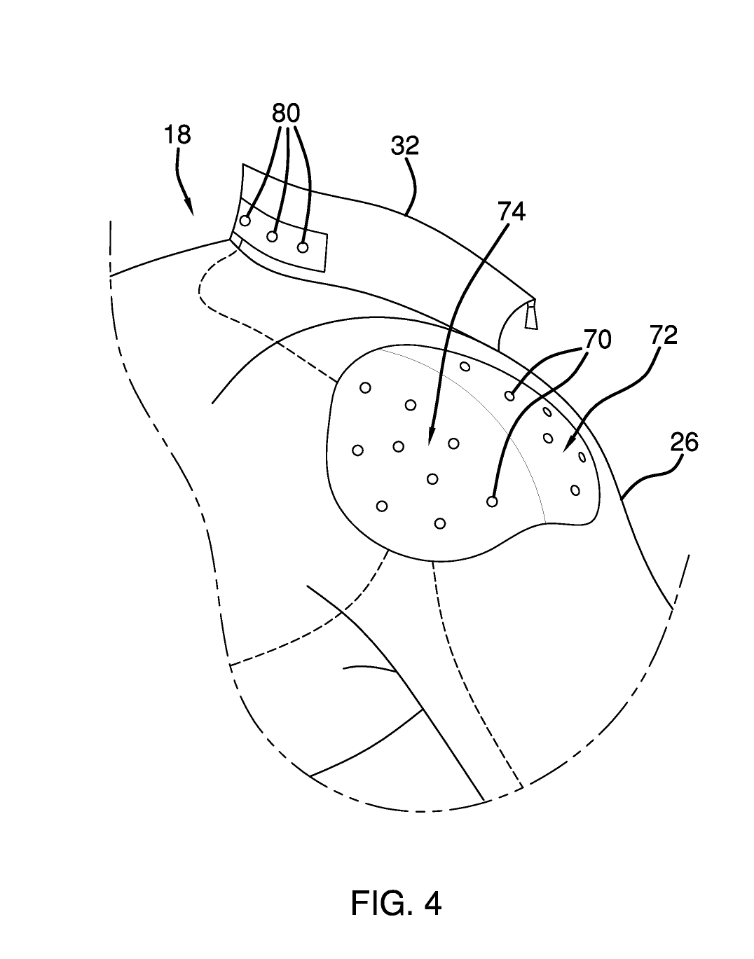

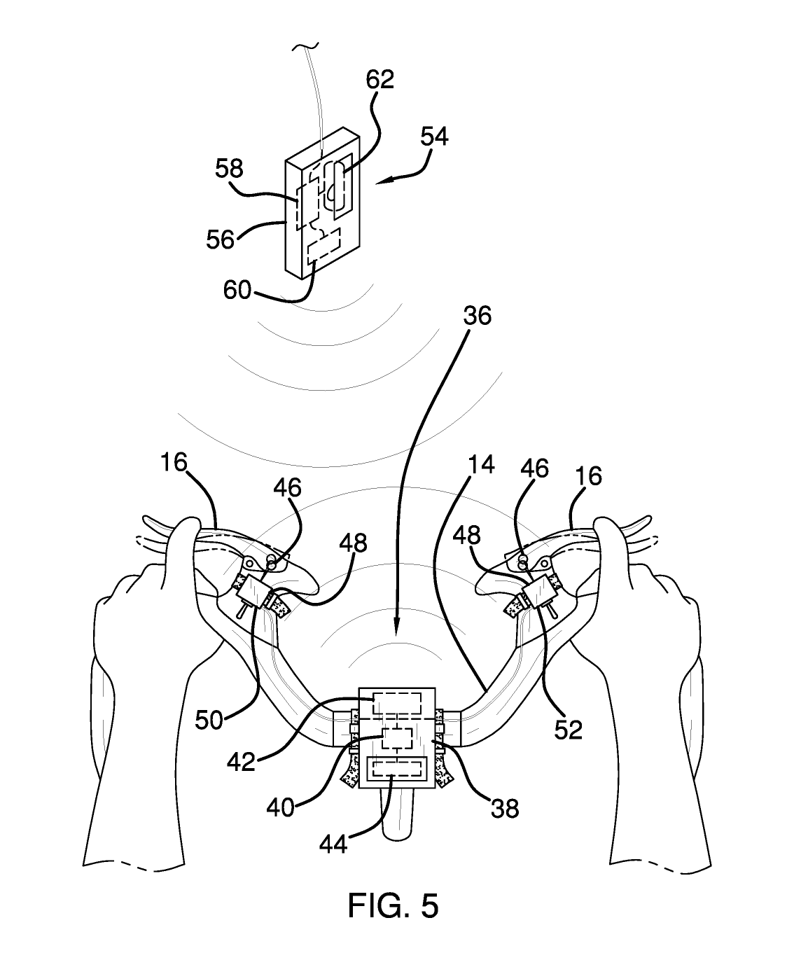

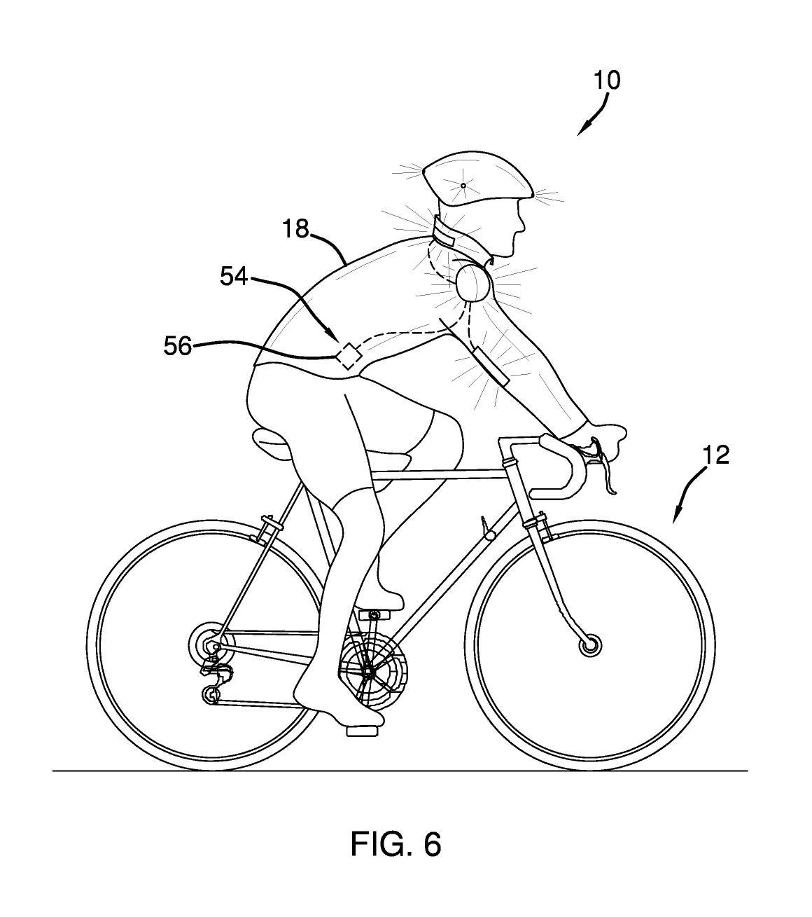

With reference now to the drawings, and in particular to FIGS. 1 through 6 thereof, a new signaling device embodying the principles and concepts of an embodiment of the disclosure and generally designated by the reference numeral 10 will be described.

As best illustrated in FIGS. 1 through 6, the bicycle signaling system 10 generally comprises a bicycle 12 that may be ridden on a roadway or the like. The bicycle 12 has handlebars 14 and a pair of brake handles 16 that are each coupled to the handlebars 14. Each of the brake handles 16 is selectively manipulated to stop the bicycle 12. A jacket 18 is provided and the jacket 18 may be worn while riding the bicycle 12. The jacket 18 has a back side 20, a front side 22, a left shoulder 24, a right shoulder 26, a left sleeve 28, a right sleeve 30 and a collar 32. Moreover, the jacket 18 may be a windbreaker, an insulated winter jacket or any other type of jacket 18. A helmet 34 is provided and the helmet 34 may be worn while riding the bicycle 12. The helmet 34 may be a bicycle helmet of any conventional design.

A signaling unit 36 is provided and the signaling unit 36 is coupled to the bicycle 12. The signaling unit 36 is in communication with each of the brake handles 16 such that the signaling unit 36 is turned on when the brake handles 16 are manipulated. The signaling unit 36 comprises a base housing 38 is releasably coupled to the bicycle 12. The base housing 38 may be retained on the bicycle 12 with a strap or any other mechanical means of releasably coupling the base housing 38 to the bicycle 12.

A base processor 40 is provided and the base processor 40 is positioned within the base housing 38. The base processor 40 selectively generates a stop sequence, a right turn sequence and a left turn sequence. The base processor 40 may be an electronic processor or the like. A transmitter 42 is provided and the transmitter 42 is positioned within the base housing 38. The transmitter 42 is electrically coupled to the base processor 40 and the transmitter 42 may be radio frequency transmitter 42 or the like. Additionally, the transmitter 42 may employ Bluetooth communication protocols. A base power supply 44 is provided and the base power supply 44 is positioned within the base housing 38. The base power supply 44 is electrically coupled to the base processor 40 and the base power supply 44 comprises at least one battery.

A pair of sensors 46 is provided and each of the sensors 46 is coupled to an associated one of the brake handles 16. In this way each of the sensors 46 detects when the associated brake handle 16 is manipulated. Each of the sensors 46 is electrically coupled to the base processor 40 such that the base processor 40 generates the stop sequence when the associated brake handle 16 is manipulated. Moreover, each of the sensors 46 may be a magnetic sensor, a micro switch or any other sensor capable of detecting when the associated brake handle 16 is manipulated.

A pair of switches 48 is provided and each of the switches 48 is releasably coupled to the handlebars 14 to be manipulated. Each of the switches 48 is aligned with an associated one of the brake handles 16 and each of the switches 48 is electrically coupled to the base processor 40. The pair of switches 48 includes a left switch 50 and a right switch 52. Moreover, each of the switches 48 may be a toggle switch, a push button or any other type of electrical switch. The base processor 40 generates the left turn sequence when the left switch 50 is manipulated and the base processor 40 generates the right turn sequence when the right switch 52 is manipulated.

A lighting unit 54 is provided and the lighting unit 54 is coupled to the jacket 18. The lighting unit 54 selectively emits light thereby facilitating the lighting unit 54 to communicate a stop signal, a right turn signal and a left turn signal. In this way the lighting unit 54 facilitates drivers on the roadway to be made aware when the bicycle 12 is stopping, making a right turn and making a left turn. The lighting unit 54 is in electrical communication with the signaling unit 36.

The lighting unit 54 comprises a remote housing 56 that is positioned within the jacket 18. The remote housing 56 may be accessible through a pocket in the jacket 18 or the like. A remote processor 58 is positioned within the remote housing 56 and the remote processor 58 may be an electronic processor or the like. A receiver 60 is positioned within the remote housing 56 and the receiver 60 is electrically coupled to the remote processor 58. The receiver 60 is in electrical communication with the transmitter 42 such that the remote processor 58 receives the stop sequence, the right turn sequence and the left turn sequence from the base processor 40. The receiver 60 may be a radio frequency receiver 60 or the like and the receiver 60 may employ Bluetooth communication protocols. In this way the receiver 60 may be synched with the transmitter 42 in the convention of Bluetooth communication.

A remote power supply 62 is positioned within the remote housing 56. The remote power supply 62 is electrically coupled to the remote processor 58. Additionally, the remote power supply 62 comprises at least one battery.

A plurality of left shoulder light emitters 64 is provided and each of left shoulder light emitters 64 is coupled to the jacket 18. Each of the left shoulder light emitters 64 selectively emits light outwardly from the jacket 18 and each of the left shoulder light emitters 64 is electrically coupled to the remote processor 58. Moreover, each of the left shoulder light emitters 64 may comprise an LED or the like.

The plurality of left shoulder light emitters 64 includes a front set of light emitters 66 that are positioned on the front side 22 of the jacket 18 corresponding to the left shoulder 24. The plurality of left shoulder light emitters 64 includes a back set of light emitters 68 that are positioned on the back side 20 of the jacket 18 corresponding to the left shoulder 24. Each of the left shoulder light emitters 64 is turned on when the base processor 40 generates the left turn sequence. Additionally, the back set of light emitters 68 may emit red colored light and the front set of light emitters 66 may emit white colored light.

A plurality of right shoulder light emitters 70 is provided and each of right shoulder light emitters 70 is coupled to the jacket 18 to emit light outwardly from the jacket 18. Each of the right shoulder light emitters 70 is electrically coupled to the remote processor 58. Moreover, each of the right shoulder light emitters 70 may be an LED or the like.

The plurality of right shoulder light emitters 70 includes a front set of light emitters 72 that are positioned on the front side 22 of the jacket 18 corresponding to the right shoulder 26. The plurality of right shoulder light emitters 70 includes a back set of light emitters 74 that are positioned on the back side 20 of the jacket 18 corresponding to the right shoulder 26. Each of the right shoulder light emitters 70 is turned on the when base processor 40 generates the right turn sequence. The back set of light emitters 74 corresponding to the right shoulder 26 may emit a red colored light and the front set of light emitters 72 corresponding to the right shoulder 26 may emit a white colored light.

A plurality of left sleeve light emitters 76 is provided and each of the left sleeve light emitters 76 is coupled to the jacket 18 to emit light outwardly from the jacket 18. Each of the left sleeve light emitters 76 is electrically coupled to the remote processor 58. Moreover, each of the left sleeve light emitters 76 is positioned on the back side 20 of the jacket 18 corresponding to the left sleeve 28. Each of the left sleeve light emitters 76 is turned on when the base processor 40 generates the left turn sequence. Each of the left sleeve light emitters 76 may comprise an LED or the like and each of the left sleeve light emitters 76 may emit a red colored light.

A plurality of right sleeve light emitters 78 is provided and each of the right sleeve light emitters 78 is coupled to the jacket 18 to emit light outwardly from the jacket 18. Each of the right sleeve light emitters 78 is electrically coupled to the remote processor 58. Additionally, each of the right sleeve light emitters 78 is positioned on the back side 20 of the jacket 18 corresponding to the right sleeve 30. Each of the right sleeve light emitters 78 is turned on when the base processor 40 generates the right turn sequence. Each of the right sleeve light emitters 78 may comprise an LED or the like and each of the right sleeve light emitters 78 may emit a red colored light. Each of the left sleeve light emitters 76 and the right sleeve light emitters 78 may be either vertically distributed on the jacket or horizontally distributed on the jacket 18.

A plurality of collar light emitters 80 is provided and each of the collar light emitters 80 is coupled to the jacket 18 to emit light outwardly from the jacket 18. Each of the collar light emitters 80 is electrically coupled to the remote processor 58 and each of the collar light emitters 80 is positioned on the back side 20 of the jacket 18 corresponding to the collar 32. Each of the collar light emitters 80 is turned on when the base processor 40 generates the stop sequence. Moreover, each of the collar light emitters 80 may comprise an LED or the like and each of the collar light emitters 80 may emit a red colored light. Each of the collar light emitters 80 may continually emit a low intensity light. Additionally, each of the collar light emitters 80 may emit a high intensity light when the base processor 40 generates the stop sequence.

A first conductor 82 extends outwardly from the collar 32 and the first conductor 82 is electrically coupled to the remote processor 58. The first conductor 82 has a distal end 84 with respect to the collar 32 and a first plug 86 is electrically coupled to the distal end 84. A plurality of helmet light emitters 87 is provided and each of the helmet light emitters 87 is coupled to the helmet 34. In this way each of the helmet light emitters 87 emits light outwardly from the helmet 34 to enhance visibility of the helmet 34 with respect to the drivers on the roadway. Each of the helmet light emitters 87 may comprise an LED or the like and the helmet light emitters 87 may be spaced apart from each other and distributed around the helmet 34.

A second conductor 88 is provided and the second conductor 88 extends outwardly from the helmet 34. The second conductor 88 has a distal end 90 with respect to the helmet 34 and a second plug 92 is electrically coupled to the distal end 90 of the second conductor 88. The second plug 92 is selectively electrically coupled to the first plug 86 such that each of the helmet light emitters is in electrical communication with the remote processor 58.

In use, each of the jacket 18 and the helmet 34 are worn when the bicycle 12 is ridden. The first plug 86 is electrically coupled to the second plug 92 and the transmitter 42 is synched with the receiver 60. Each of the collar light emitters 80 emits the high intensity light when either of the brake handles 16 is manipulated. In this way the collar light emitters 80 communicates to drivers on the roadway that the bicycle 12 is stopping. Each of the right shoulder light emitters 70 and the right sleeve light emitters 78 emits light when right switch 52 is manipulated. In this way the right shoulder light emitters 70 and the right sleeve light emitters 78 communicate to drivers on the roadway that the bicycle 12 is making a right hand turn. Each of the left shoulder light emitters 64 and the left sleeve light emitters 76 emits light when the left switch 50 is manipulated. In this way the left shoulder light emitters 64 and the left sleeve light emitters 76 communicate to drivers on the roadway the bicycle 12 is making a left hand turn.

With respect to the above description then, it is to be realized that the optimum dimensional relationships for the parts of an embodiment enabled by the disclosure, to include variations in size, materials, shape, form, function and manner of operation, system and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A bicycle signaling system comprising:
a bicycle being configured to be ridden, said bicycle having handlebars and a pair of brake handles each being coupled to said handlebars wherein each of said brake handles is configured to be manipulated to stop said bicycle;
a jacket being configured to be worn while riding said bicycle;
a helmet being configured to be worn while riding said bicycle;
a signaling unit being coupled to said bicycle, said signaling unit being in communication with each of said brake handles such that said signaling unit is turned on when said brake handles are manipulated; and
a lighting unit being coupled to said jacket wherein said lighting unit is configured to selectively emit light thereby facilitating said lighting unit to communicate a stop signal, a right turn signal and a left turn signal, said lighting unit being in electrical communication with said signaling unit.

2. The system according to claim 1, wherein said jacket has a back side and a front side, said jacket having a left shoulder, a right shoulder, a left sleeve, a right sleeve and a collar.

3. The system according to claim 1, wherein said signaling unit comprises:
a base housing being releasably coupled to said bicycle; and
a base processor being positioned within said base housing, said base processor selectively generating a stop sequence, a right turn sequence and a left turn sequence.

4. The system according to claim 3, further comprising a transmitter being positioned within said base housing, said transmitter being electrically coupled to said base processor.

5. The system according to claim 3, further comprising a base power supply being positioned within said base housing, said base power supply being electrically coupled to said base processor, said base power supply comprising at least one battery.

6. The system according to claim 3, further comprising a pair of sensors, each of said sensors being coupled to an associated one of said brake handles such that each of said sensors detects when said associated brake handle is manipulated, each of said sensors being electrically coupled to said base processor such that said base processor generates said stop sequence when said associated brake handle is manipulated.

7. The system according to claim 3, further comprising a pair of switches, each of said switches being releasably coupled to said handlebars wherein each of said switches is configured to be manipulated, each of said switches being aligned with an associated one of said brake handles, each of said switches being electrically coupled to said base processor, said pair of switches including a left switch and a right switch, said processor generating said left turn sequence when said left switch is manipulated, said processor generating said right turn sequence when said right switch is manipulated.

8. The system according to claim 1, wherein said lighting unit comprises:
a remote housing being positioned within said jacket; and
a remote processor being positioned within said remote housing.

9. The system according to claim 8, further comprising:
a transmitter;
a base processor selectively generating a stop sequence, a right turn sequence and a left turn sequence; and
a receiver being positioned within said remote housing, said receiver being electrically coupled to said remote processor, said receiver being in electrical communication with said transmitter such that said remote processor receives said stop sequence, said right turn sequence and said left turn sequence from said base processor.

10. The system according to claim 8, further comprising a remote power supply being positioned within said remote housing, said remote power supply being electrically coupled to said remote processor, said remote power supply comprising at least one battery.

13. The system according to claim 9, further comprising:
said jacket having a front side, a back side and a left shoulder;
a plurality of left shoulder light emitters, each of left shoulder light emitters being coupled to said jacket wherein each of said left shoulder light emitters is configured to emit light outwardly from said jacket, each of said left shoulder light emitters being electrically coupled to said remote processor; and
said plurality of left shoulder light emitters including a front set of light emitters being positioned on said front side of said jacket corresponding to said left shoulder, said plurality of left shoulder light emitters including a back set of light emitters being positioned on said back side of said jacket corresponding to said left shoulder, each of said left shoulder light emitters being turned on when said base processor generates said left turn sequence.

14. The system according to claim 9, further comprising:
said jacket having a back side, a front side and a right shoulder;
a plurality of right shoulder light emitters, each of right shoulder light emitters being coupled to said jacket wherein each of said right shoulder light emitters is configured to emit light outwardly from said jacket, each of said right shoulder light emitters being electrically coupled to said remote processor; and
said plurality of right shoulder light emitters including a front set of light emitters being positioned on said front side of said jacket corresponding to said right shoulder, said plurality of right shoulder light emitters including a back set of light emitters being positioned on said back side of said jacket corresponding to said right shoulder, each of said right shoulder light emitters being turned on said when base processor generates said right turn sequence.

15. The system according to claim 9, further comprising:
said jacket having a back side and a left sleeve; and
a plurality of left sleeve light emitters, each of said left sleeve light emitters being coupled to said jacket wherein each of said left sleeve light emitters is configured to emit light outwardly from said jacket, each of said left sleeve light emitters being electrically coupled to said remote processor, each of said left sleeve light emitters being positioned on said back side of said jacket corresponding to said left sleeve, each of said left sleeve light emitters being turned on when said base processor generates said left turn sequence.

16. The system according to claim 9, further comprising:
said jacket having a back side and a right sleeve; and
a plurality of right sleeve light emitters, each of said right sleeve light emitters being coupled to said jacket wherein each of said right sleeve light emitters is configured to emit light outwardly from said jacket, each of said right sleeve light emitters being electrically coupled to said remote processor, each of said right sleeve light emitters being positioned on said back side of said jacket corresponding to said right sleeve, each of said right sleeve light emitters being turned on when said base processor generates said right turn sequence.

17. The system according to claim 9, further comprising:
said jacket having a back side and a collar; and
a plurality of collar light emitters, each of said collar light emitters being coupled to said jacket wherein each of said collar light emitters is configured to emit light outwardly from said jacket, each of said collar light emitters being electrically coupled to said remote processor, each of said collar light emitters being positioned on said back side of said jacket corresponding to said collar, each of said collar light emitters being turned on when said base processor generates said stop sequence.

18. A bicycle signaling system comprising:
a bicycle being configured to be ridden, said bicycle having handlebars and a pair of brake handles each being coupled to said handlebars wherein each of said brake handles is configured to be manipulated to stop said bicycle;
a jacket being configured to be worn while riding said bicycle, said jacket having a back side and a front side, said jacket having a left shoulder, a right shoulder, a left sleeve, a right sleeve and a collar,
a helmet being configured to be worn while riding said bicycle;
a signaling unit being coupled to said bicycle, said signaling unit being in communication with each of said brake handles such that said signaling unit is turned on when said brake handles are manipulated, said signaling unit comprising:
a base housing being releasably coupled to said bicycle;
a base processor being positioned within said base housing, said base processor selectively generating a stop sequence, a right turn sequence and a left turn sequence,
a transmitter being positioned within said base housing, said transmitter being electrically coupled to said base processor, and
a base power supply being positioned within said base housing, said base power supply being electrically coupled to said base processor, said base power supply comprising at least one battery,
a pair of sensors, each of said sensors being coupled to an associated one of said brake handles such that each of said sensors detects when said associated brake handle is manipulated, each of said sensors being electrically coupled to said base processor such that said base processor generates said stop sequence when said associated brake handle is manipulated, and
a pair of switches, each of said switches being releasably coupled to said handlebars wherein each of said switches is configured to be manipulated, each of said switches being aligned with an associated one of said brake handles, each of said switches being electrically coupled to said base processor, said pair of switches including a left switch and a right switch, said processor generating said left turn sequence when said left switch is manipulated, said processor generating said right turn sequence when said right switch is manipulated; and
a lighting unit being coupled to said jacket wherein said lighting unit is configured to selectively emit light thereby facilitating said lighting unit to communicate a stop signal, a right turn signal and a left turn signal, said lighting unit being in electrical communication with said signaling unit, said lighting unit comprising:
a remote housing being positioned within said jacket,
a remote processor being positioned within said remote housing,
a receiver being positioned within said remote housing, said receiver being electrically coupled to said remote processor, said receiver being in electrical communication with said transmitter such that said remote processor receives said stop sequence, said right turn sequence and said left turn sequence from said base processor,
a remote power supply being positioned within said remote housing, said remote power supply being electrically coupled to said remote processor, said remote power supply comprising at least one battery,
a plurality of left shoulder light emitters, each of left shoulder light emitters being coupled to said jacket wherein each of said left shoulder light emitters is configured to emit light outwardly from said jacket, each of said left shoulder light emitters being electrically coupled to said remote processor, said plurality of left shoulder light emitters including a front set of light emitters being positioned on said front side of said jacket corresponding to said left shoulder, said plurality of left shoulder light emitters including a back set of light emitters being positioned on said back side of said jacket corresponding to said left shoulder, each of said left shoulder light emitters being turned on when said base processor generates said left turn sequence,
a plurality of right shoulder light emitters, each of right shoulder light emitters being coupled to said jacket wherein each of said right shoulder light emitters is configured to emit light outwardly from said jacket, each of said right shoulder light emitters being electrically coupled to said remote processor, said plurality of right shoulder light emitters including a front set of light emitters being positioned on said front side of said jacket corresponding to said right shoulder, said plurality of right shoulder light emitters including a back set of light emitters being positioned on said back side of said jacket corresponding to said right shoulder, each of said right shoulder light emitters being turned on said when base processor generates said right turn sequence,
a plurality of left sleeve light emitters, each of said left sleeve light emitters being coupled to said jacket wherein each of said left sleeve light emitters is configured to emit light outwardly from said jacket, each of said left sleeve light emitters being electrically coupled to said remote processor, each of said left sleeve light emitters being positioned on said back side of said jacket corresponding to said left sleeve, each of said left sleeve light emitters being turned on when said base processor generates said left turn sequence,
a plurality of right sleeve light emitters, each of said right sleeve light emitters being coupled to said jacket wherein each of said right sleeve light emitters is configured to emit light outwardly from said jacket, each of said right sleeve light emitters being electrically coupled to said remote processor, each of said right sleeve light emitters being positioned on said back side of said jacket corresponding to said right sleeve, each of said right sleeve light emitters being turned on when said base processor generates said right turn sequence,
a plurality of collar light emitters, each of said collar light emitters being coupled to said jacket wherein each of said collar light emitters is configured to emit light outwardly from said jacket, each of said collar light emitters being electrically coupled to said remote processor, each of said collar light emitters being positioned on said back side of said jacket corresponding to said collar, each of said collar light emitters being turned on when said base processor generates said stop sequence,
a first conductor extending outwardly from said collar, said first conductor being electrically coupled to said remote processor, said first conductor having a distal end with respect to said collar, said distal end having a first plug being electrically coupled thereto,
a plurality of helmet light emitters, each of said helmet light emitters being coupled to said helmet wherein each of said helmet light emitters is configured to emit light outwardly from said helmet, and
a second conductor extending outwardly from said helmet, said second conductor having a distal end with respect to said helmet, said distal end of said second conductor having a second plug being electrically coupled thereto, said second plug being selectively electrically coupled to said first plug such that each of said helmet light emitters is in electrical communication with said remote processor.
